(19) United States
(12) Patent Application Publication
(10) Pub. No.: US 2011/0144842 A1
(43) Pub. Date: Jun. 16, 2011

(54) DC-TO-DC CONVERTING APPARATUS WITH COMMUNICATION FUNCTION FOR VEHICLE

(75) Inventors: Chia-Lung NI, Taipei (TW); Chi-Yi YU, Taipei (TW); Wen-Sheng TSAO, Taipei (TW); Bo-Wen TANG, Taipei (TW); Chin-Hou CHEN, Taipei (TW); Ku-Yu HSIAO, Taipei (TW)

(73) Assignee: DELTA ELECTRONICS, INC., Taoyuan County (TW)

(21) Appl. No.: 12/689,711

(22) Filed: Jan. 19, 2010

(30) Foreign Application Priority Data
Dec. 10, 2009 (TW) 098142387

(51) Int. Cl. G06F 19/00

(52) U.S. Cl. 701/22; 180/65.275

(57) ABSTRACT

A DC-to-DC converting apparatus with communication function for a vehicle is applied to an electric vehicle or a hybrid vehicle. The electric vehicle or the hybrid vehicle includes a vehicle control system. The DC-to-DC converting apparatus with communication function for a vehicle includes a DC-to-DC converter, a control circuit is electrically connected to the DC-to-DC converter, and a system communication interface is electrically connected to the control circuit and the vehicle control system. The working status of the DC-to-DC converter is detected by the control circuit and is informed to the vehicle control system through the system communication interface. The control circuit is controlled to control the DC-to-DC converter by the vehicle control system through the system communication interface.

### BACKGROUND OF THE INVENTION

1. Field of the Invention

The present invention relates to a DC-to-DC converting apparatus, and more particularly to a DC-to-DC converting apparatus with communication function for a vehicle.

2. Description of Prior Art

Because the energy crisis and global warming are seriously affecting all life on the earth, no matter how much progress is made by the developed world in energy saving and carbon reduction. However, these issues were caused by increasing concentrations of greenhouse gases resulting from human activity such as fossil fuel burning and deforestation. Accordingly, the development of the electric vehicle and the hybrid vehicle is necessary.

The electric vehicle or the hybrid vehicle has both a high-voltage battery and a low-voltage battery. The high-voltage battery is used to drive motor through an inverter to provide electric power to the electric vehicle or the hybrid vehicle. Also, the low-voltage battery is used to provide electric power to accessory electrical equipment of the electric vehicle or the hybrid vehicle. In general, gasoline vehicles use an internal combustion engine to produce electric power to charge the low-voltage battery. Because electric vehicles do not carry an internal combustion engine, electric vehicles need to install a low-voltage generator to charge the low-voltage battery to prevent the low-voltage battery from operating in an under-voltage condition after using over a period of time.

Reference is made to FIG. 1 which is a schematic view of charging a low-voltage battery of a prior art internal combustion engine. The internal combustion engine is not suitable for the electric vehicle or the hybrid vehicle because the high-voltage DC electric power can not be converted into the low-voltage DC electric power through the prior art internal combustion engine.

Reference is made to FIG. 2 which is a schematic view of charging a low-voltage battery of a prior art electric vehicle or hybrid vehicle. A high-voltage charger 10a can charge a high-voltage battery 20a. In addition, a DC-to-DC converter 304a is used to convert a high-voltage DC electric power into a low-voltage DC electric power to charge a low-voltage battery 50b or provide electric power to a low-voltage equipment 40b.

However, a prior art vehicle control system (not shown) of the electric vehicle or the hybrid vehicle can not identify a working status of the DC-to-DC converted 304a. In general, a vehicle power system must have the ability to detect all kinds of failures and handle them in time to improve power reliability; otherwise, the battery could be damaged even the car driving could be dangerous. The art prior vehicle control system can not obtain the electric power information so that the energy-saving efficiency of the electric vehicle or the hybrid vehicle can not be satisfied.

### SUMMARY OF THE INVENTION

In order to overcome the above-mentioned shortages, the present invention provides a DC-to-DC converting apparatus with communication function for a vehicle to detect and remove the vehicle failures.

In order to achieve above-mentioned objectives, a DC-to-DC converting apparatus with communication function for a vehicle is applied to an electric vehicle or a hybrid vehicle, the electric vehicle or the hybrid vehicle includes a vehicle control system. In addition, the DC-to-DC converting apparatus includes a DC-to-DC converter, a control circuit, and a system communication interface. The control circuit is electrically connected to the DC-to-DC converter, and the system communication interface is electrically connected to the control circuit and the vehicle control system. Moreover, a working status of the DC-to-DC converter is detected by the control circuit and is informed to the vehicle control system through the system communication interface; and the control circuit is controlled to control the DC-to-DC converter by the vehicle control system through the system communication interface.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a schematic view of charging a low-voltage battery of a prior art internal combustion engine;

FIG. 2 is a schematic view of charging a low-voltage battery of a prior art electric vehicle or hybrid vehicle;

FIG. 3 is a block diagram of a DC-to-DC converting apparatus with communication function for a vehicle according to the present invention; and

FIG. 4 is a flow chart of controlling the DC-to-DC converting apparatus with communication function for a vehicle.

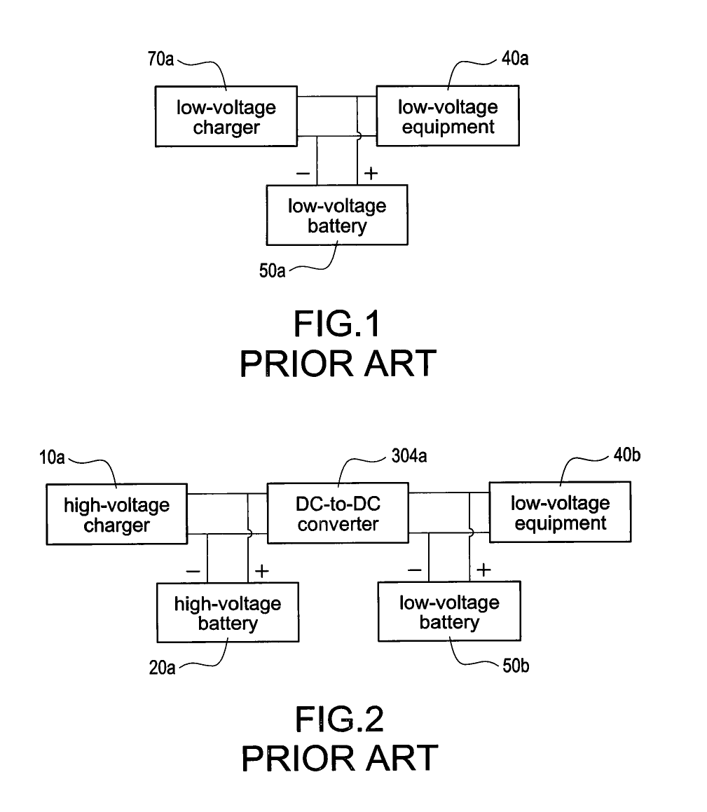

### DETAILED DESCRIPTION OF THE INVENTION

Reference will now be made to the drawing figures to describe the present invention in detail.

A DC-to-DC converting apparatus with communication function for a vehicle is disclosed to provide a DC-to-DC converter, which converts a high-voltage DC electric power into a low-voltage DC electric power, to solve the above-mentioned problems of the vehicle power system. Namely, the DC-to-DC converter is used to facilitate the vehicle power system to detect a power-supplying condition and all kinds of failures in order to improve power reliability and provide strong safety for vehicles.

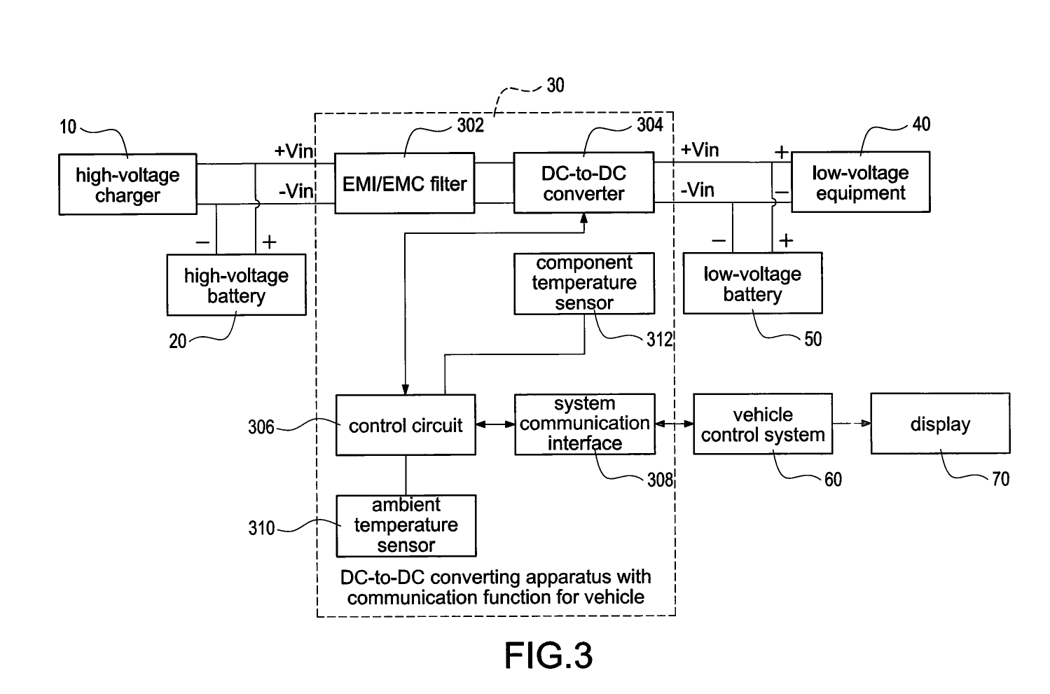

Reference is made to FIG. 3 which is a block diagram of a DC-to-DC converting apparatus with communication function for a vehicle according to the present invention. The DC-to-DC converting apparatus 30 with communication function for a vehicle is applied to an electric vehicle (not shown) or a hybrid vehicle (not shown). The electric vehicle or the hybrid vehicle includes a vehicle control system 60, a high-voltage battery 20, a low-voltage equipment 40, a low-voltage battery 50, and a display 70. The DC-to-DC converting apparatus with communication function for a vehicle 30 includes an EMI/EMC filter 302, a DC-to-DC converter 304, a control circuit 306, a system communication interface 308, an ambient temperature sensor 310, and a component temperature sensor 312.

The control circuit 306 is electrically connected to the DC-to-DC converter 304, the system communication interface 308, the ambient temperature sensor 310, and a component temperature sensor 312. The DC-to-DC converter 304 is electrically connected to the EMI/EMC filter 302, the control circuit 306, the low-voltage equipment 40, and the low-voltage battery 50. The EMI/EMC filter 302 is electrically connected to the DC-to-DC converter 304, a high-voltage charger 10, and the high-voltage battery 20. The vehicle control system 60 is electrically connected to the system communication interface 308 and the display 70.

In the present invention, the working status of the DC-to-DC converter 304 is detected by the control circuit 306 and is informed to the vehicle control system 60 through the system communication interface 308. Also, the control circuit 306 is controlled to control the DC-to-DC converter 304 by the vehicle control system 60 through the system communication interface 308. The detailed description will be made hereinafter.

High-frequency or low-frequency noises are produced when switching electronic equipment is operated, and the noises are conducted or radiated to interfere with accessory electrical equipment, such as a car radio. Accordingly, the EMI/EMC filter 302 can be used to suppress the high-frequency or low-frequency interference.

The DC-to-DC converter 304 can be an isolated or non-isolated DC-to-DC converter. The DC-to-DC converter 304 is an electronic circuit, which converts a DC source from one voltage level to another. In the embodiment, the DC-to-DC converter 304 can convert a higher-voltage DC voltage (about 200 to 400 volts) of the high-voltage charger 10 or the high-voltage battery 20 into a fixed or variable lower-voltage DC voltage (about 10 to 16 volts) and supply the lower-voltage DC voltage to the low-voltage battery 50 and the low-voltage equipment 40.

The control circuit 306 is used to control the DC-to-DC converter 304 and detect a real-time operating condition of the DC-to-DC converter 304. The detailed description will be made hereinafter. Also, the detected real-time operating condition is stored for the vehicle control system 60 reading. Furthermore, the control circuit 306 is used to receive commands of the vehicle control system 60 to control the DC-to-DC converter 304.

The system communication interface 308 can be an inter-integrated circuit (I2C), a PM bus, a local interconnect network (LIN), or a controller area network (CAN). The vehicle control system 60 can be a trip computer or an electronic control unit (ECU). The low-voltage equipment 40 can be the electronic equipment, such as headlights, or a car audio. The component temperature sensor 312 is used to measure temperature of components of the DC-to-DC converting apparatus 30. The ambient temperature sensor 310 is used to measure ambient temperature of the DC-to-DC converting apparatus 30.

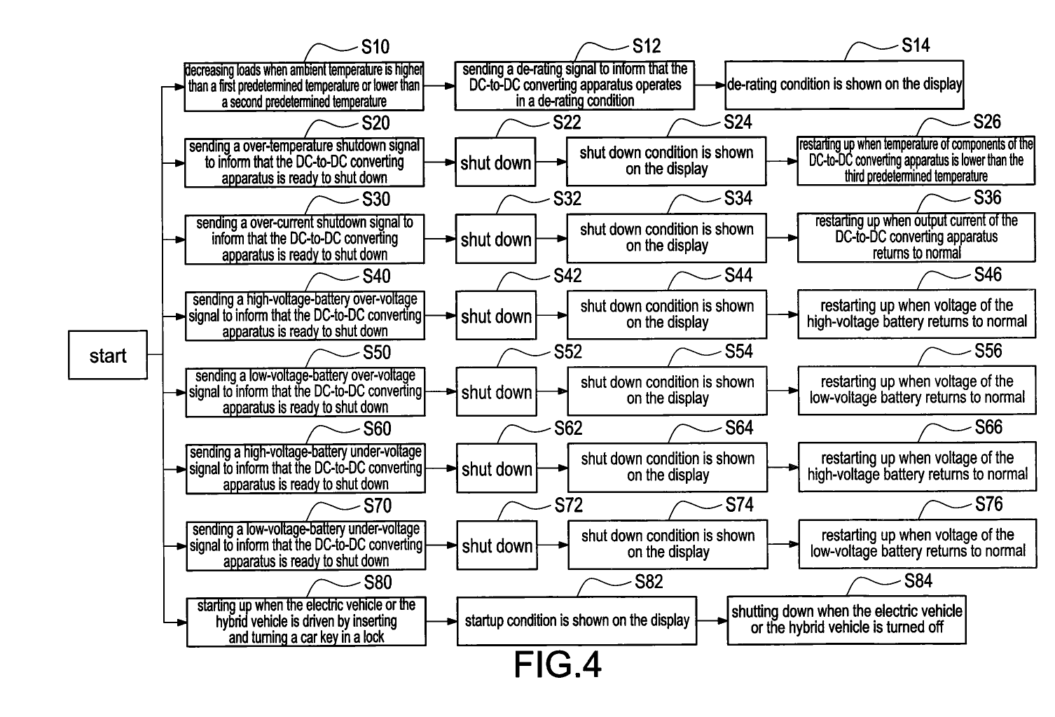

Reference is made to FIG. 4 which is a flow chart of controlling the DC-to-DC converting apparatus with communication function for a vehicle. Also FIG. 3 is shown for reference. The detailed description will be made as follows.

1. The DC-to-DC converting apparatus 30 with communication function for a vehicle decreases loads (de-rating) when ambient temperature of the DC-to-DC converting apparatus 30 is higher than a first predetermined temperature or lower than a second predetermined temperature (S10). More particularly, the first predetermined temperature is higher than the second predetermined temperature. Afterward, the DC-to-DC converting apparatus 30 sends a de-rating signal to inform the vehicle control system 60 that the DC-to-DC converting apparatus 30 operates in a de-rating condition (S12). The de-rating condition is shown on the display 70 (S14).

For example, the ambient temperature of the DC-to-DC converting apparatus 30 is possibly up to 50° C. when the electric vehicle or the hybrid vehicle is driven in a scorching hot zone, such as a desert. However, temperature of components possibly increases 60° C. if the DC-to-DC converting apparatus 30 operates in a full-load condition. Hence, the temperature of the vehicle is totally up to 110° C. It is assumed that an upper temperature limit is 100° C. to the DC-to-DC converting apparatus 30 for safety usage. Therefore, the DC-to-DC converting apparatus 30 shuts down due to the over-temperature operation. Accordingly, the DC-to-DC converting apparatus 30 has to decrease loads to decrease temperature of components so that the temperature of the vehicle is lower than the upper temperature limit.

An embodiment is provided to install a temperature sensing component, such as a negative temperature coefficient (NTC) thermistor, which closed by a lower-temperature component of the DC-to-DC converting apparatus 30 to measure ambient temperature thereof. For example, the DC-to-DC converting apparatus 30 decreases loads when an under ambient temperature (−40° C.˜0° C.) or an over ambient temperature (40° C.˜75° C.) is measured by the ambient temperature sensor 310.

2. The DC-to-DC converting apparatus 30 with communication function for a vehicle sends a over-temperature shutdown signal to the vehicle control system 60 to inform the vehicle control system 60 that the DC-to-DC converting apparatus 30 is ready to shut down (S20) when ambient temperature of the DC-to-DC converting apparatus 30 is higher than a third predetermined temperature. Afterward, the DC-to-DC converting apparatus 30 shuts down (S22). The shutdown condition is shown on the display 70 (S24). The DC-to-DC converting apparatus 30 restarts up when temperature of components of the DC-to-DC converting apparatus 30 is lower than the third predetermined temperature (S26).

An embodiment is provided to install a temperature sensing component, such as a negative temperature coefficient (NTC) thermistor, which closed by a higher-temperature component of the DC-to-DC converting apparatus 30 to measure temperature of components thereof. For example, the DC-to-DC converting apparatus 30 shuts down when the temperature of components, which detected by the component temperature sensor 312, is higher than the third predetermined temperature (assumed to be 100° C.). In addition, the DC-to-DC converting apparatus 30 restarts up until the measured temperature of components is lower than the third predetermined temperature.

3. The DC-to-DC converting apparatus 30 with communication function for a vehicle sends a over-current shutdown signal to the vehicle control system 60 to inform the vehicle control system 60 that the DC-to-DC converting apparatus 30 is ready to shut down (S30) when the DC-to-DC converting apparatus 30 operates in an over-current condition or a shorted-circuit condition. Afterward, the DC-to-DC converting apparatus 30 shuts down (S32). The shutdown condition is shown on the display 70 (S34). The DC-to-DC converting apparatus 30 restarts up when output current of the DC-to-DC converting apparatus 30 is less than a rated current and the over-current condition is no longer detected (S36).

4. The DC-to-DC converting apparatus 30 with communication function for a vehicle sends a high-voltage-battery over-voltage signal to the vehicle control system 60 to inform the vehicle control system 60 that the DC-to-DC converting apparatus 30 is ready to shut down when the high-voltage battery 20 operates in an over-voltage condition (S40). Afterward, the DC-to-DC converting apparatus 30 shuts down (S42). The shutdown condition is shown on the display 70 (S44). The DC-to-DC converting apparatus 30 restarts up when voltage of the high-voltage battery 20 returns to normal (S46).

For example, the DC-to-DC converting apparatus 30 shuts down when a voltage, which produced because of switching a relay, is added to voltage of the high-voltage battery 20 or the high-voltage battery 20 is charged by the high-voltage charger 10 to occur an over-voltage condition. However, the DC-to-DC converting apparatus 30 restarts up when voltage of the high-voltage battery 20 returns to normal.

5. The DC-to-DC converting apparatus 30 with communication function for a vehicle sends a low-voltage-battery over-voltage signal to the vehicle control system 60 to inform the vehicle control system 60 that the DC-to-DC converting apparatus 30 is ready to shut down when the low-voltage battery 50 operates in an over-voltage condition (S50). Afterward, the DC-to-DC converting apparatus 30 shuts down (S52). The shutdown condition is shown on the display 70 (S54). The DC-to-DC converting apparatus 30 restarts up when voltage of the low-voltage battery 50 returns to normal (S56).

For example, the DC-to-DC converting apparatus 30 shuts down when the high-voltage battery 20 operates in a component malfunctioned condition or a high-voltage feedback condition. However, the DC-to-DC converting apparatus 30 restarts up when voltage of the low-voltage battery 50 returns to normal.

6. The DC-to-DC converting apparatus 30 with communication function for a vehicle sends a high-voltage-battery under-voltage signal to the vehicle control system 60 to inform the vehicle control system 60 that the DC-to-DC converting apparatus 30 is ready to shut down when the high-voltage battery 20 operates in an under-voltage condition (S60). Afterward, the DC-to-DC converting apparatus 30 shuts down (S62). The shutdown condition is shown on the display 70 (S64). The DC-to-DC converting apparatus 30 restarts up when voltage of the high-voltage battery 20 returns to normal (S66).

For example, the DC-to-DC converting apparatus 30 shuts down when the high-voltage battery 20 operates in an under-voltage condition due to electricity consumer or a voltage sagging condition. However, the DC-to-DC converting apparatus 30 restarts up when voltage of the high-voltage battery 20 returns to normal.

7. The DC-to-DC converting apparatus 30 with communication function for a vehicle sends a low-voltage-battery under-voltage signal to the vehicle control system 60 to inform the vehicle control system 60 that the DC-to-DC converting apparatus 30 is ready to shut down when the low-voltage battery 50 operates in an under-voltage condition (S70). Afterward, the DC-to-DC converting apparatus 30 shuts down (S72). The shutdown condition is shown on the display 70 (S74). The DC-to-DC converting apparatus 30 restarts up when voltage of the low-voltage battery 50 returns to normal (S76).

For example, the DC-to-DC converting apparatus 30 shuts down when abnormal conditions, such as component malfunctioned, or voltage sagging conditions, occur in the low-voltage battery 50. However, the DC-to-DC converting apparatus 30 restarts up when voltage of the low-voltage battery 50 returns to normal.

8. The vehicle control system 60 controls the DC-to-DC converting apparatus 30 with communication function for a vehicle to be started up when the electric vehicle or the hybrid vehicle is driven by inserting and turning a car key in a lock (S80). Afterward, the startup condition is shown on the display 70 (S82). In addition, the vehicle control system 60 controls the DC-to-DC converting apparatus 30 to be shut down when the electric vehicle or the hybrid vehicle is turned off (S84). Namely, a two-way communication is between the vehicle control system 60 and the DC-to-DC converting apparatus 30. For another example, the vehicle control system 60 controls the DC-to-DC converting apparatus 30 to be shut down when abnormal conditions, such as waterlogged, firefighting, or crashed conditions, occur in the vehicle control system 60 (or the electric vehicle or the hybrid vehicle).

The DC-to-DC converting apparatus 30 with communication function for a vehicle is used to convert the high-voltage DC electric power into the low-voltage DC electric power in order to provide electric power desired to the low-voltage battery 50 and the low-voltage equipment 40. In addition, the vehicle control system 60 is connected to the DC-to-DC converting apparatus 30 through control equipment, such as a MCU, or other software and hardware to obtain the electric power information. Accordingly, the vehicle control system 60 is used to control the DC-to-DC converting apparatus 30 to achieve the optimal performance.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A DC-to-DC converting apparatus with communication function for a vehicle applied to an electric vehicle or a hybrid vehicle, the electric vehicle or the hybrid vehicle comprising a vehicle control system, and the DC-to-DC converting apparatus comprising:
a DC-to-DC converter;
a control circuit electrically connected to the DC-to-DC converter; and
a system communication interface electrically connected to the control circuit and the vehicle control system;
wherein a working status of the DC-to-DC converter is detected by the control circuit and is informed to the vehicle control system through the system communication interface; and the control circuit is controlled to control the DC-to-DC converter by the vehicle control system through the system communication interface.

2. The DC-to-DC converting apparatus in claim 1, further comprising an EMI/EMC filter electrically connected to the DC-to-DC converter.

3. The DC-to-DC converting apparatus in claim 1, wherein the system communication interface is an inter-integrated circuit (I2C), a PM bus, a local interconnect network (LIN), or a controller area network (CAN).

4. The DC-to-DC converting apparatus in claim 1, further comprising a component temperature sensor electrically connected to the control circuit to measure temperature of components of the DC-to-DC converting apparatus.

5. The DC-to-DC converting apparatus in claim 1, further comprising an ambient temperature sensor electrically connected to the control circuit to measure ambient temperature of the DC-to-DC converting apparatus.

6. The DC-to-DC converting apparatus in claim 1, wherein the vehicle control system is electrically connected to a display, and the working status of the DC-to-DC converter detected by the control circuit is shown on the display.
